(19) United States
(12) Patent Application Publication
(10) Pub. No.: US 2008/0285984 A1
(43) Pub. Date: Nov. 20, 2008

(54) Device and Method for the Homogenisation of Optical Communication Signals

(76) Inventor: Philip Thomas Hughes, Plymouth (GB)

Correspondence Address: UNGARETTI & HARRIS LLP;INTELLECTUAL PROPERTY GROUP - PATENTS, 70 WEST MADISON STREET, SUITE 3500, CHICAGO, IL, 60602-4224, US

(21) Appl. No.: 11/663,491

(22) PCT Filed: Sep. 19, 2005
(86) PCT No.: PCT/GB05/03600

§ 371 Date: Nov. 26, 2007

(30) Foreign Application Priority Data
Sep. 23, 2004 (GB) 0421236.1

(51) Int. Cl. H04B 10/12

(52) U.S. Cl. 398/201

(57) ABSTRACT

The invention provides a method and apparatus for providing a uniform output from an optical transmitter. The invention comprises at least one discrete light source (30), and a housing (38) defining an internally reflecting volume (42) for light from the at least one light source, the housing having a light exit aperture (46) for light from the at least one light source. The reflecting volume is adapted to produce in an extended image surface multiple reflected images (50) of the at least one light source, and the light exit aperture is arranged to emit light from the multiple reflected images. An output lens (48) is employed in front of the light exit aperture for controlling the angular distribution of the light emitted from the at least one light source and the multiple reflected images by way of the light exit aperture.

### FIELD OF THE INVENTION

The present invention relates to an optical device for the homogenisation of optical radiation from discrete sources, and to a method for the same. In particular, the present invention relates to an optical device and method for providing a uniform output from an optical transmitter.

The invention, in its preferred form at least, provides for the homogenisation and controlled collimation of free-space radiation originating from one or more embedded discrete optical radiation sources (for example, a light emitting diode (LED) or laser).

The invention, in conjunction with discrete LED or laser elements, may have application in transmitters of communications systems making use of signals carried over free-space optical radiation. However, the invention is not restricted to the visible region, and the principles of the invention may be employed with any wavelengths from the hard ultraviolet (from about 50 nm) upwards. In practice, the longest wavelengths that are likely to be used are in the mm-wave RF band (above 100 GHz). This being understood, in the rest of this document, the electromagnetic radiation that the invention is designed to transmit or collect will be referred to as “light”, or “optical”.

### BACKGROUND TO THE INVENTION

When an optical medium is used for commercial wireless communication purposes:—
1. As much as possible of the signal light generated by the source(s) should be transmitted into free space by the transmitter in a well-defined radiation pattern. Conversely, the transmitter system should absorb as small an amount as possible of the light generated by the source(s) before it exits the transmitter.
2. To ensure that high data rates can be supported, optical temporal dispersion in the apparatus should be minimised.
3. To transmit data at high rates, it is necessary to modulate the light source(s) very rapidly (of the order of 10's of pico-second (Ps) to 10's of nano-second (ns) in practice). This is easier to achieve if the or each source is physically small (ensuring a low device capacitance and hence fast response time). Such small sources may not have the desired angular radiation or physical size characteristics required by the communications system.
4. It is desirable to be able to utilise a selected light source, irrespective of its intrinsic radiation pattern.
5. The source(s) and associated optics should be as simple, cheap and spatially compact as possible.
6. “Dead-spots” in the transmit pattern, and hence problems with receiver positioning, should be avoided.
7. The transmitter radiation pattern should be well defined and easily controllable.
8. In high data-rate applications, it is desirable to minimise the signal path lengths from the electronics to the sources. Therefore it is preferable to mount the light source(s) on a printed circuit board (PCB) very near the electronics and to avoid the use of signal wires between the source(s) and the PCB.

In practice, in order to fulfil all of these requirements, an optical device for generating communications signals needs to be designed to:—
1. Sum the power of individual discrete sources.
2. Emit substantially 100% of the available power in a well-defined angular pattern of a uniform power density.
3. Involve as short a ray path length (i.e. minimal number of reflections) as possible for all the emergent rays.
4. Be as simple, compact and cheap to produce as possible.

### PRIOR ART

Devices to sum the light from a number of discrete sources, collimate the light (i.e. control or alter the angular distribution pattern of emergent radiation) and homogenate the light (provide uniform or isotropic illumination over an area of space) for various purposes are known.

However, the known devices suffer from a number of significant disadvantages, and are generally unable to offer two or more of the above features simultaneously. In particular, the prior art devices tend to suffer from one or more of the following:—
1. Limited control/directionality of angular radiation pattern. Very often, practical light sources have smaller angular patterns than that required in an ideal transmitter.
2. Lack of efficiency. Power is often lost in collimation.
3. Anisotropy (inhomogeneity) due to the use of discrete sources. It is desirable to ensure that the emitted radiation is as uniform as possible over a given area in a communications application as this avoids problems with receiver location.
4. Poor temporal dispersion due to multiple reflections. To prevent the distortion of high data-rate signals, it is desirable to have as few internal reflections as possible.
5. High cost/complexity.

For example, consider the following straightforward conventional optical systems and their use in the communications field as shown in FIGS. 1a-d.

### Diffuser

A diffuser is a classic means of achieving uniformity of illumination from one or more discrete sources 10. This is achieved by passing light emitted from the source(s) 10 through a filter screen 12, for example a ground-glass sheet, which scatters the radiation into many differing directions simultaneously. This is illustrated in FIG. 1a, which shows a single light source 10 mounted on a PCB 10a. However, power emission efficiency and definition of angular radiation pattern are difficult to control.

### Collimator

A collimator uses one or more opaque screens 14 each with an aperture 16 of well-defined shape, the screens 14 being arranged so that the centres of the apertures 16 are collinear. These apertures 16 allow rays from a certain range of directions to emerge, whereas all other rays are absorbed by the screens 14 as illustrated in FIG. 1b. This cuts down angular range without affecting homogeneity.

A collimator 14 is often used in conjunction with a diffuser 12 to limit the angular pattern of the light emitted from the filter screen 12. The key problem with this arrangement is again efficiency: a substantial amount of the emergent radiation produced by the source(s) 10 may be absorbed by the screen material.

### Lens

A system of lenses 18 (potentially just a single converging or diverging lens) suitably placed can alter the angular properties of light emergent from the source(s) 10 without the waste associated with a collimator aperture. This is shown in FIG. 1c. However, such an arrangement does not help with homogeneity. If a number of sources are placed on the focal plane of a converging lens, the “image” (i.e. the outgoing radiation pattern) consists of a number of non-uniform spots—unless the sources are physically contiguous and of uniform properties across their diameter, which is difficult, if not impossible, to arrange in practice.

### Shaped Mirror

A mirror of special geometry can be employed to reflect the light transmitted from the source(s) 10. A simple mirror geometry that is well known to focus and sum the power of one or more sources 10 is a parabolic reflector 20, as shown in FIG. 1d. However, this arrangement has various drawbacks. Firstly, it is difficult to employ such a mirror without detaching the source(s) 10 from the PCB 10a on which it (they) are mounted. Thus, wires 22 need to be provided to connect the light source(s) 10 to the PCB 10a. Another consideration is dimensional instability due to temperature variations. The emergent pattern of light would then be temperature dependent. For these reasons, a mirror of special geometry is undesirable for high-speed communications applications.

Other applications, in which the light from a number of separate light sources is summed, occur in the visible lighting industry. Such applications are mainly concerned with producing high visibility light beams or beacons from a number of low-intensity discrete sources. For example, WO02052190 describes an arrangement including a large number of light emitting diode (LED) sources mounted inside a reflecting cavity of cylindrical (or more complex) shape in order to create a powerful directional light source from a large number of weak sources. A similar arrangement is disclosed in JP9265807.

However, control over, and the range of, the angular illumination are limited and the area of illumination is also small with these prior art devices. Further, the provision of a substantial area of uniform illumination is not possible with these arrangements.

It should be pointed out that LED technology for visible lighting purposes has advanced recently (mainly in the automotive industry). However, these advances are not applicable to the field of application of this invention: optical high-speed communications for the reasons just given.

Thus, it is difficult with conventional systems to achieve simultaneously all the features (including collimation and homogeneity over a sufficient area of illumination) desirable for an optical transmission system.

### SUMMARY OF THE INVENTION

The present invention seeks to overcome the disadvantages of the prior art.

According to one aspect of the present invention, there is provided an optical device for providing a uniform output from an optical transmitter, comprising:
at least one discrete light source,
a housing defining an internally reflecting volume for light from the at least one light source, the housing having a light exit aperture for light from the at least one light source,
wherein the reflecting volume is adapted to produce in an extended image surface multiple reflected images of the at least one light source and wherein the light exit aperture is arranged to emit light from the multiple reflected images, and
an output lens in front of the light exit aperture for controlling the angular distribution of the light emitted from the at least one light source and the multiple reflected images by way of the light exit aperture.

According to another aspect of the invention, there is provided a method for providing a uniform output from an optical transmitter, comprising:
providing at least one discrete light source,
forming an internally reflecting volume for light from the at least one light source to produce in an extended image surface multiple reflected images of the at least one light source,
directing light from the multiple reflected images out of the internally reflecting volume through a light exit aperture, and
employing an output lens in front of the light exit aperture for controlling the angular distribution of the light emitted from the at least one light source and the multiple reflected images by way of the light exit aperture.

The invention in its preferred form described below is an optical device/method suitable for use in high-speed data communications systems, comprising three main components: 1) one or more discrete light sources, 2) at least one mirror-cavity surrounding the light source(s), and 3) a projection lens system.

The use of the mirror cavity allows for the efficient summation and effective homogenisation of the optical radiation from the source(s) and enables the generation of an output radiation pattern that is substantially uniform, both along and perpendicular to the direction of radiation, over a significant area. The advantage of this in an optical communications system is that it avoids problems with receiver positioning. The provision of a projection lens system ensures that the output radiation pattern can be flexibly defined.

Thus, the invention, at least in its preferred form, has a number of advantages, namely:—
1. The sources and associated optics may be simple, and cheap and spatially very compact. Such sources may have any angular radiation characteristics.
2. The device can be mounted on a PCB very near associated electronics, avoiding the need for wires to take signals off the PCB.
3. Virtually all the signal light generated by the sources can be transmitted into free space by the device in a well-defined pattern with very low optical temporal dispersion.

In addition, the device/method according to the invention employs a simple mirror geometry and is therefore not particularly sensitive in its operation to temperature or pressure, and hence can work in a number of extreme environments.

The present invention as described below has several significant advantages in the field of optical data communications in relation to the known prior art, namely:—
1. Plural light sources capable of being modulated in the 10's to 10000's of pico-second levels are employed, and temporal dispersion (due to excessive numbers of reflections/variations in path length) is minimised.
2. Light power may be summed efficiently to substantially 100%.
3. Precise and variable control of the emergent pattern of illumination is possible.
4. The uniformity of the illuminated area is important in a communications application, since a few percent difference in illumination can mean the difference between signals being received properly or not at all, and the invention permits such uniformity to be achieved.

### BRIEF DESCRIPTION OF THE DRAWINGS

The invention is described further, by way of example, with reference to the accompanying drawings, in which:—

FIGS. 1a to 1d are diagrammatic views illustrating the operation of various prior art optical devices, in which FIG. 1a shows an optical diffuser, FIG. 1b shows an optical collimator, FIG. 1c shows a lens system and FIG. 1d shows a parabolic reflector;

FIG. 2 is a diagrammatic view illustrating an infinite array of light sources;

FIGS. 3a and 3b are diagrammatic plan and side views illustrating the present invention;

FIG. 4 is a diagrammatic side view illustrating a mirror box and light source array as shown in FIG. 3 in combination with a converging lens;

FIG. 5 is a diagrammatic plan view illustrating a multiplicity of reflected images as seen by a nearby observer of the mirror box shown in FIG. 4;

FIGS. 6a and 6b are diagrammatic plan and side views illustrating a further embodiment of the present invention;

FIG. 7 is a diagrammatic view illustrating alternative lens covers for individual light sources within the mirror box of FIG. 3 or 6; and

FIG. 8 is a diagrammatic side view illustrating the effect of modifying the mirror box of FIG. 3 or 6.

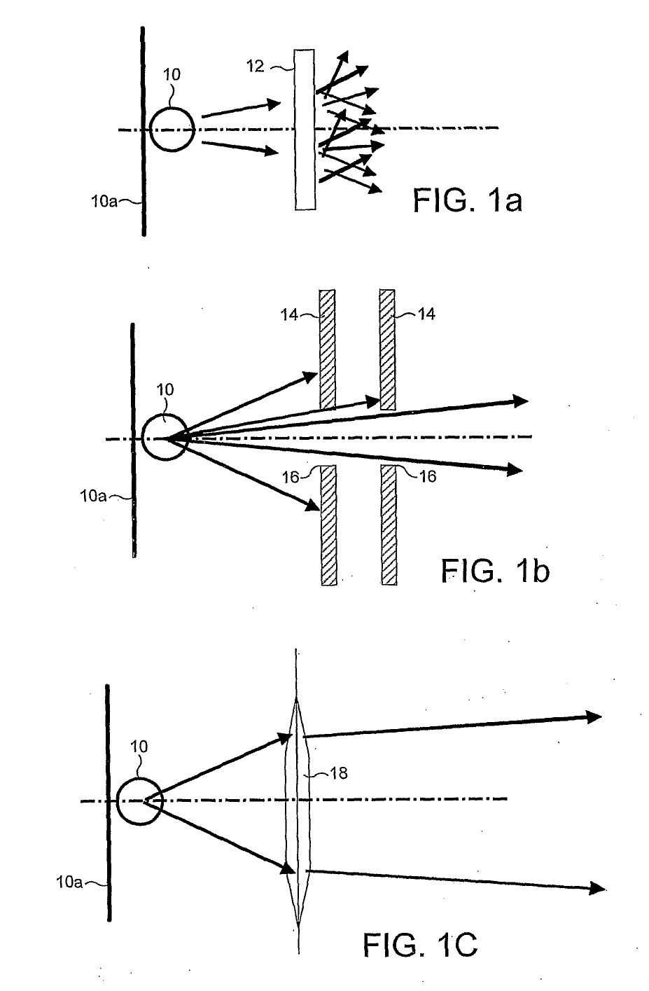

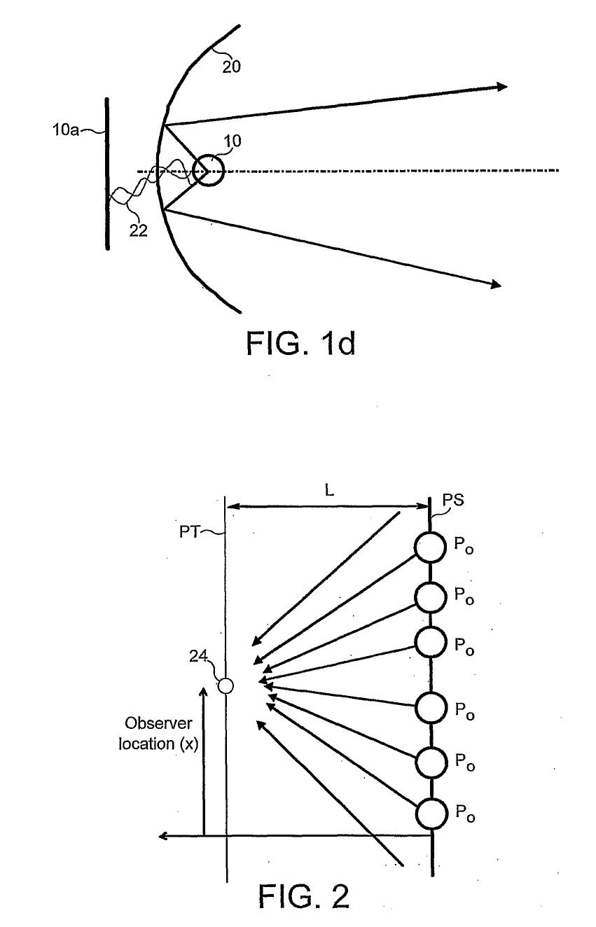

### BACKGROUND THEORY

The background to the present invention will be described first with reference to FIG. 2.

To achieve uniform illumination on a target plane PT using discrete sources Pₒ, whose individual illumination patterns are substantially different from the required illumination pattern, it is necessary to use several sources, for example plural discrete sources, arranged at intervals in a source plane PS as illustrated in FIG. 2. Ignoring phase, the expression below gives the power density at a point (x,y) on the target plane PT at an orthogonal distance L from the source plane PS on which there are (2N+1)×(2M+1) identical sources of power PO located at arbitrary points (Xᵢⱼ,Yᵢⱼ):—

$${\sum }_{I = - M}^{M} {\sum }_{j = - N}^{N} \frac{{P}_{o} L}{{Δφ [ {( x - {X}_{ij} )}^{2} + {( y - {Y}_{ij} )}^{2} + {L}^{2} ]}^{3 / 2}}$$

It can be seen by inspection that, if the number of sources Pₒ is very large (N and M>>1, strictly, infinity) and the source locations are arranged in a regular array, then wherever an observer 24 is located on the target plane, the power density has the same value. Thus the observer 24 should see a very large number of sources Pₒ, or the same number of sources Pₒ, whatever their location.

Providing an infinite number, or very large number, of sources Pₒ is impractical. However, by using a number of plane mirrors arranged parallel to each other and orthogonal to the source and target planes PS and PT, a finite number of (i.e. one or more) sources Pₒ can, in principle, produce an infinite series of reflected image (or virtual) sources which are entirely equivalent to real sources located at their respective image positions. To enable the observer 24 to see inside the “mirror cavity” thus formed, a lens system may be placed so as to generate an image of an open face of the cavity. In this way, the observer sees a large number of image sources independent of his position on the target plane PT.

It should be noted that the light from a mirror cavity having plane orthogonal and parallel mirrors would emerge from the cavity in directions parallel to the directions of radiation of the source light.

### PREFERRED EMBODIMENTS

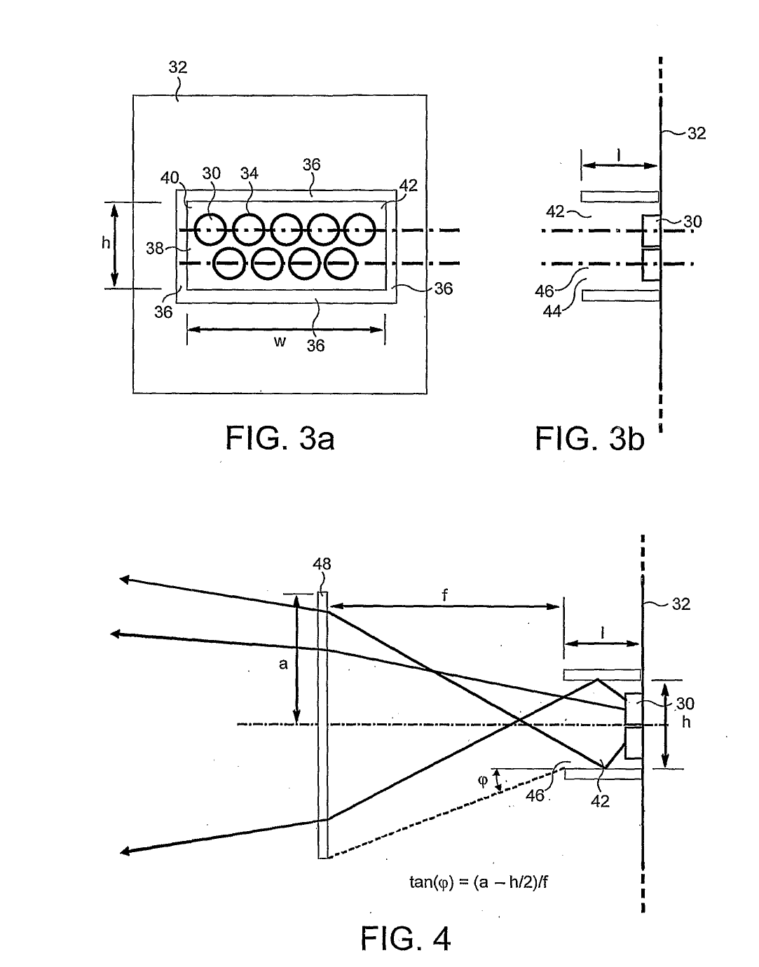

The next section describes how the invention can be realised in practice. A preferred embodiment of the invention will now be described with reference to FIGS. 3 to 5.

A plurality of discrete light sources 30, preferably fast LEDs or lasers or laser diodes or a combination of these, are mounted on a planar surface 32 effectively constituting a source plane PS. The light sources are arranged at regular intervals, for example in a linear array 34 as illustrated in FIG. 3a or in a matrix array, and are mounted normal to the plane of the surface 32. To encourage compactness, the array 34 employed for the sources in FIG. 3a corresponds with a section of a hexagonally close-packed array with very small gaps between the sources 30. It will be obvious, however, that many other configurations are possible. The surface 32 is preferably formed from, or coated with, a reflective material.

Extending from the surface 32, and at right angles to the surface, are a number of additional reflective surfaces of finite extent. The exact number and layout of these reflective surfaces governs the shape of the output illumination. In the present instance, in order to achieve a rectangular area of illumination, two pairs of vertical walls 36 are provided forming a box 38 containing the light sources 30. The interior surfaces 40 of the walls 36 facing into the box 38 are arranged to be reflective, either through the walls 36 being formed from, or coated with, a reflective material. These surfaces 40 will be called “mirror planes”. Each pair of mirror planes 40 consists of two finite parallel planes placed on opposite sides of the light source array 34, and the two pairs of mirror planes meet at right angles. These four planes 40 and the surface 32 together form a rhombohedral reflecting volume or cavity 42 surrounding the light sources 30. The remaining side of the box 38 forms an open face 44 constituting a rectangular light exit aperture 46 for the volume or cavity 42, which gives rise to a rectangular area of illumination from the light volume or cavity 42.

Such a reflecting volume or mirror cavity 42 can be simply fabricated in a number of ways:—
1) From sheets of appropriately sized reflecting material joined along the edges of the box 38.
2) By milling a rhombohedral cavity 42 in a suitable solid material, for example a brass block, and then either utilising self-reflective properties of the material or coating the inside surfaces of the cavity 42 with a highly reflecting layer, for example by means of silver plating.
3) By moulding a solid block of transparent material (e.g. plastics, acrylic) in the shape of the volume 42, then covering the outer surfaces apart from the face 44 with reflecting material, and drilling holes in the source plane surface 32 to mount the discrete sources 30.

As shown in FIG. 4, a lens or lens system 48 is also placed at a distance from the exit aperture 46 of the cavity 42 in the direction normal to the source plane surface 32. This distance corresponds with the effective focal length of the lens 48 so that the image of the light sources 30 at the exit aperture 46 lies in the focal plane of the lens 48 for reasons discussed below. In other words, the focal plane of the lens 48 is co-planar with the exit aperture 46. The lens 48 may be optically coated in order to prevent reflections and improve output efficiency. For simplicity, in the present instance, the lens 48 comprises a single converging lens, such as a Fresnel lens.

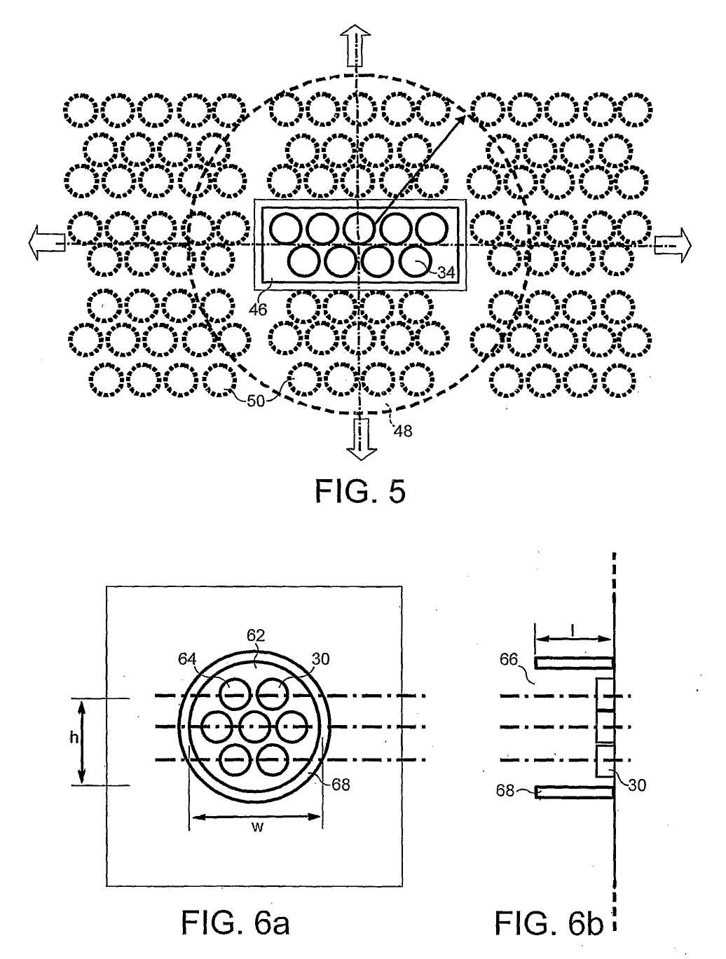

If each source 30 radiates into 2π steradian in the forward direction towards the exit aperture 46 of the cavity 42, then an observer at the aperture 46 of the cavity 42 would not only see the sources 30 directly but would also, in principle, see an infinite series of images or reflections 50 of the source array 34 in a two-dimensional plane parallel to the aperture 46, these reflections being due to the mirror planes 40. This is illustrated in FIG. 5. Thus, since the aperture 46 lies in the focal plane of the lens 48, this infinite series of reflections is the image that the lens 48 projects into space, and ultimately, onto the target plane PT.

Referring to FIGS. 3a and 3b, let the height and width (representing the vertical and horizontal dimensions) of the open face 44 or exit aperture 46 of the mirror cavity 42 be h and w respectively. Let the length of the mirror planes in a direction perpendicular to the source plane surface 32 be l. The lens 48 is placed at a distance f from the exit aperture 46 of the cavity 42 in the direction of the normal to the source plane PS, the distance f being the effective focal length of the lens 48 as indicated.

If the sources 30 do not radiate into 2π steradian as stated but instead radiate into a maximum semi-angle, θ, then the apparent radius of the visible extent of the series of reflections of the sources 30 (ie the image horizon) as shown in FIG. 5 is given by:—

Rᵥₑᵣₜ<l tan(θ)+h/2,R_{horiz}<l tan(θ)+w/2 in the vertical and horizontal planes respectively. (1)

It can be seen that as θ→π/2, then Rₓ→∞, as expected.

If the target plane is situated a distance L from the lens system focal plane, then the illumination pattern will have a height H and width W given by:—

H=h(L/f), and W=w(L/f). (2)

Thus, by a suitable choice of h, w, and f, the illumination area, or angles, can be precisely controlled independently of the size of the source array 34.

If each of the sources has a power output Pₒ and there are N of them, the power density on the target plane is:—

Pₜ=NPₒf²/hwL² (3)

Since there is no collimation absorption, in principle, 100% of the emergent power impinges on the target plane PT in the illuminated zone.

In the illuminated zone, the observer 24, or a receiver, would be able to see a substantial number of the sources 30 and their reflections, independently of the location of the observer/receiver. This gives rise to a uniform illumination of the target plane PT.

Note that, if the mirror planes are strictly parallel and orthogonal, then the emergent light from the aperture 46 of the mirror cavity 42 will have the same angular distribution as each source's emergent light. If the lens diameter is 2a, then, in order that no light escapes the lens, the emergent angles (φ_{horiz} and φᵥₑᵣₜ), the lens radius and the aperture dimensions are related through the following constraints:—

tan(φ_{horiz})=(a−w/2)/f, and (4)

tan(φᵥₑᵣₜ)=(a−h/2)/f. (5)

The approximate number of reflections in the horizontal and vertical planes, as represented in FIG. 3a, in this geometry is given by:—

n˜l tan(θ)/h (6)

If we wish to keep this number n small (say, less than 10), for temporal dispersion reasons, then we have:—

l tan(θ)h<10, (7)

which for typical sources of θ˜30 deg, gives an upper limit on the mirror box length to height ratio of:—

l/h/<17.3 (8)

It can be seen that, by a simple choice of length to height ratio for the mirror box 38, the temporal dispersion of the system can be controlled. It should be noted that the expression for the source image horizon given in equation (1) can be written:—

Rᵥₑᵣₜ<h(n+½)(similarly R_{horiz}<w(n+½)) (9)

Thus, the larger the number of reflections permitted the larger will be the image horizon (R). In the example, if n˜10, then Rvert˜10.5 h, if h=15.0 mm, then R˜157.5 mm, and similarly for the horizontal plane.

The source spatial density is N/hw on the source plane. The area of the images is πR_{horiz}Rᵥₑᵣₜ=hw (n+½)², so the total number of (real and image) sources visible (M) is:

M˜N/hx×πhw(n+½)²=Nπ(n+½)². (10)

Thus, the number of apparent sources increases with the square of the number of reflections, meaning that a large number of apparent sources can be created with a small number of reflections—satisfying two critical requirements from above.

### FURTHER EMBODIMENTS AND MODIFICATIONS

The embodiment of FIGS. 3 to 5 envisages a rectangular mirror cavity 42 and light exit aperture 46 of fixed size. However, this is not essential. If the geometry were intended to be variable, i.e. a variable output illumination area is desired, then at least one of the mirror planes could be arranged to be moveable by means such as manual adjustment or a servo motor mechanism.

Another possibility is to employ a circular, or more generally elliptical, section mirror cavity 62 and light exit aperture 66, as shown in FIGS. 6a and 6b. To achieve this configuration, one or more curved mirror surfaces could be used and, in the arrangement of FIG. 6, a cylindrical mirror box 68 is employed with a hexagonal array 64 of light sources 30. This produces an image pattern with cylindrical symmetry, with a large number of virtual sources being generated from a small number of real sources.

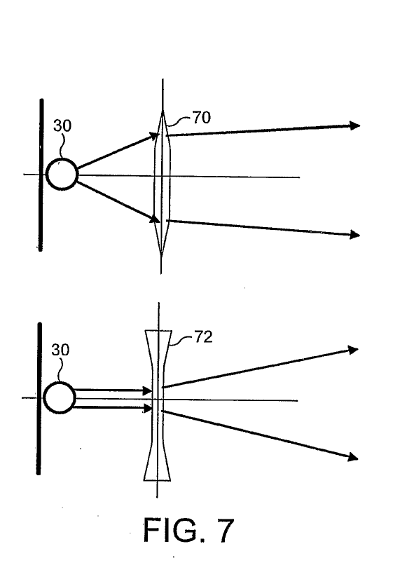

Another possible variation is shown in FIG. 7. In the embodiment of FIGS. 3 to 5, the light sources 30 are bare. In practice, however, it may be desirable to modify the radiation emitted by each of the light sources 30.

For example, if each individual source 30 has a “raw” radiation emission having a large angle of radiation 2θ, the angle of the radiation 2θemitted by the source 30 can be reduced by placing a converging lens cover 70 over one or more of the sources 30. Alternatively, if the angle of radiation 2θ is zero or near zero, for example as in a laser source, then the radiation angle 2θ can be broadened by covering the source with a transparent, diverging lens 72 placed at a suitable distance away from the source 30.

In this way, virtually any source radiation angle can be accommodated.

In the embodiments described thus far, the individual light sources 30 are provided within the mirror cavity 42, 62 and light it directly. A further modification would be to locate the light sources 30 outside the mirror cavity 42, 62 and to supply the light from the light sources 30 to the mirror cavity via one or more suitable light guides, such as an optical fibre light guide or a light pipe.

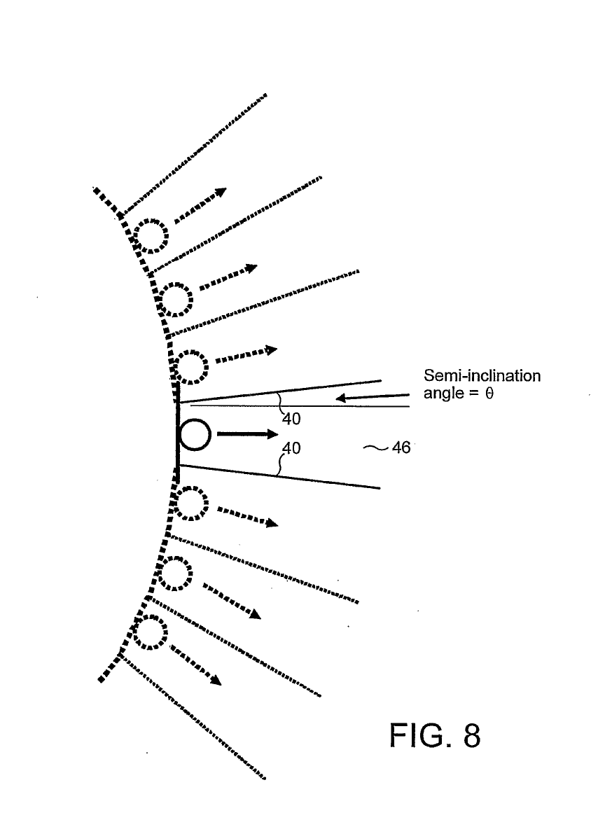

In another modification, as shown in FIG. 8, the mirror planes 40 in one or both of the opposed pairs of such planes could be angled slightly relative to one another, for example away from each other in the direction of the exit aperture 46, so as to make the virtual image of the source plane appear to be curved. If both pairs of mirror planes are so angled, then the virtual image plane will appear to be spherical, whereas if only one such pair is angled the virtual image plane will appear to be cylindrical. The curvature would then be such as to make the observer appear to be on the inside of the sphere or cylinder.

This would alter the output light emerging from the exit aperture 46 so as to increase the angular spread in one or both orthogonal directions, depending one whether one or both pair of mirror planes 40 were angled from the parallel orientation. However, the above analysis still applies, with the source semi-angle (θ) replaced by (θ-α), where α is the semi-inclination of the previously parallel mirror cavity sides.

It should be noted that the optimum inclination (α) is dependent on the sources used and the required output configuration for the optical device according to the invention.

What is claimed is:

1. An optical device for providing a uniform output from an optical transmitter, comprising:
at least one discrete light source,
a housing defining an internally reflecting volume for light from the at least one light source, the housing having a light exit aperture for light from the at least one light source,
wherein the reflecting volume is adapted to produce in an extended image surface multiple reflected images of the at least one light source and wherein the light exit aperture is arranged to emit light from the multiple reflected images, and
an output lens in front of the light exit aperture for controlling the angular distribution of the light emitted from the at least one light source and the multiple reflected images by way of the light exit aperture.

2. A device according to claim 1 comprising an array of discrete light sources.

3. A device according to claim 2 in which the light sources are arranged in a hexagonal array.

4. A device according to any one of claims 1 to 3 in which the internally reflecting volume is provided by a cavity within the housing having a reflective wall surface or surfaces.

5. A device according to any of claims 1 to 3 in which the reflecting volume is provided by a transparent block having a wall surface or surfaces coated with a coating whose interior surface is reflective.

6. A device according to any preceding claim in which the internally reflecting volume is formed between two pairs of opposed walls arranged so that the reflecting volume has a rectangular section.

7. A device according to claim 6 in which each pair of opposed walls is parallel and the reflecting volume is of constant section, and in which the extended image surface is an image plane.

8. A device according to claim 6 in which each pair of opposed walls is arranged to diverge in the direction of the light exit aperture and the section of the reflecting volume increases towards the light exit aperture, and in which the extended image surface is a curvilinear image surface.

9. A device according to any of claims 1 to 5 in which the reflecting volume is bounded by a curved wall surface defining an elliptical section.

10. A device according to claim 9 in which the wall surface is cylindrical and the section of the reflecting volume is constant, and in which the extended image surface comprises an image plane.

11. A device according to claim 9 in which the curved wall surface is frusto-conical and the section of the reflecting volume increases towards the light exit aperture, and in which the extended image surface is a curvilinear image surface.

12. A device according to any preceding claim in which a focal plane of the lens coincides with the light exit aperture.

13. A device according to any preceding claim, in which the output lens is a converging lens.

14. device according to any preceding claim in which the at least one light source is located within the internally reflecting volume, which surrounds the at least one light source.

15. A device according to claim 14 further comprising at least one source lens arranged within the internally reflecting volume over the at least one light source for controlling the angular range of light emitted by the at least one light source.

16. A device according to claim 15 in which the at least one source lens is a converging lens.

17. A device according to claim 15 in which the at least one source lens is a diverging lens.

18. A method for providing a uniform output from an optical transmitter, comprising:

19. An optical device for providing a uniform output from an optical transmitter, comprising:
a plurality of discrete light sources,
a housing defining an internally reflecting volume for light from the light sources,
the housing having at least one mirror surface providing the internally reflecting volume and adapted to reflect light from the discrete light sources to produce in an extended image surface multiple reflected image sources,
the housing further having a light exit aperture for light from the discrete light sources and the multiple reflected image sources, and,
a projection lens arrangement disposed in front of the light exit aperture for controlling the angular distribution of the light emitted from the discrete light sources and the multiple reflected image sources by way of the light exit aperture and for projecting said emitted light onto a target.

20. A device according to claim 19 comprising a regular array of the discrete light sources.

21. A device according to claim 20 in which the array is a hexagonal array.

22. A device according to claim 19 in which the internally reflecting volume is provided by a cavity within the housing having at least one reflective wall surface.

23. A device according to claim 19 in which the reflecting volume is provided by a transparent block having at least one wall surface coated with a coating whose interior surface is reflective.

24. A device according to claim 19 in which the internally reflecting volume is formed between two pairs of opposed walls arranged so that the reflecting volume has a rectangular section.

25. A device according to claim 24 in which each pair of opposed walls is parallel and the reflecting volume is of constant section, and in which the extended image surface is an image plane.

26. A device according to claim 24 in which each pair of opposed walls is arranged to diverge in the direction of the light exit aperture and the section of the reflecting volume increases towards the light exit aperture, and in which the extended image surface is a curvilinear image surface.

27. A device according to claim 19 in which the reflecting volume is bounded by a curved wall surface defining an elliptical section.

28. A device according to claim 27 in which the wall surface is cylindrical and the section of the reflecting volume is constant, and in which the extended image surface comprises an image plane.

29. A device according to claim 27 in which the curved wall surface is frusto-conical and the section of the reflecting volume increases towards the light exit aperture, and in which the extended image surface is a curvilinear image surface.

30. A device according to claim 19 in which a focal plane of the projection lens arrangement coincides with the light exit aperture.

31. A device according to claim 19 in which the projection lens arrangement comprises a converging lens.

32. A device according to claim 19 in which the light sources are located within the internally reflecting volume, which surrounds the light sources.

33. A device according to claim 32 further comprising a respective source lens arranged within the internally reflecting volume over each light source for controlling the angular range of light emitted by the said light source.

34. A device according to claim 33 in which the source lenses are converging lenses.

35. A device according to claim 33 in which the source lenses are diverging lenses.

36. A method for providing a uniform output from an optical transmitter, comprising:
providing a plurality of discrete light sources,
forming an internally reflecting volume for light from the discrete light sources from at least one mirror surface adapted to reflect light from the discrete light sources to produce in an extended image surface multiple reflected image sources,
directing light from the discrete light sources and the multiple reflected image sources out of the internally reflecting volume through a light exit aperture, and,
employing a projection lens arrangement in front of the light exit aperture for controlling the angular distribution of the light emitted from the discrete light sources and the multiple reflected image sources by way of the light exit aperture and for projecting said emitted light onto a target.
